(19) United States
(12) Patent Application Publication
(10) Pub. No.: US 2024/0416483 A1
(43) Pub. Date: Dec. 19, 2024

(54) NOZZLE FOR CONVERTING A LIQUID CO2 INTO A DRY ICE

(71) Applicant: enotech GmbH, Dieburg (DE)

(72) Inventors: Pascal PESCHKE, Darmstadt (DE); Dennis KREHER, Dieburg (DE); Arthur RUDEK, Liederbach (DE); Christian SCHLEGEL, Darmstadt (DE)

(73) Assignee: enotech GmbH, Dieburg (DE)

(21) Appl. No.: 18/211,323

(22) Filed: Jun. 19, 2023

(51) Int. Cl. B24C 1/00; B08B 7/00

(52) U.S. Cl. CPC B24C 1/003; B08B 7/0021

(57) ABSTRACT

A nozzle for converting or separating a liquid/gaseous CO₂ into a dry ice includes a housing, a spherical chamber configured in the housing, and a first tangential inlet configured on the housing to tangentially inject the liquid CO₂ into the spherical chamber. The tangential injection creates a helical flow of the liquid CO₂ inside the spherical chamber causing flocculation at a desired pressure and temperature to ensure optimum phase transformation to create the dry ice. Further, a second tangential inlet is configured adjacent to the first tangential inlet to transfer a first secondary material into the spherical chamber to achieve highest possible degree of mixing, and resulting in the highest possible utilization of sub-cooling potential. Furthermore, one or more inlets are configured in the housing to receive a second secondary material to support expansion-based flocculation by thermally insulating the housing to achieve precooling of the spherical chamber.

### BACKGROUND OF THE INVENTION

### 1. Field of the Invention

The present invention generally relates to a device for manufacturing dry ice, and more particularly relates to a nozzle for converting a liquid CO₂ into a dry ice or for separating a gaseous CO₂ from a gas mixture and converting it into a dry ice.

### 2. Description of the Related Art

Dry Ice is the common name for solid carbon dioxide (CO₂). It gets this name because it does not melt into a liquid when heated; instead, it changes directly into a gas (a process known as sublimation). Since dry ice is simply carbon dioxide, it's safe and also non-toxic and, even when scrubbed. Due to its extremely low temperature of −78° C., dry ice is often used as an alternative to refrigeration for foodstuffs and medical supplies.

In addition, special dry ice pellets are used for industrial cleaning. As Ireland's premier dry ice specialist, Polar Ice provides dry ice solutions for a diverse range of customers, in areas such as:
Hospitals & Clinics
Food Processing & Distribution
Industrial Cleaning and Technical.
Processes
Theatrical and Special Effects

Dry Ice is manufactured by compressing and cooling gaseous CO₂ under high pressure to initially produce liquid CO₂. The liquid is then allowed to expand under a reduced pressure to produce CO₂ snow, and finally, this snow is compressed by a hydraulic press into convenient Dry Ice blocks, slices or pellets. The density of the compressed CO₂ snow depends on the applied pressure and the pressure time. Generally, at −109° F., dry ice is significantly colder than the 32° F. surface temperature of regular ice.

Dry ice machines are available in several different types, but fundamentally, they operate on the same basic principle that was-introducing a phase change in carbon dioxide by taking the liquid form and passing it through an expansion valve thus allowing it to expand under atmospheric pressure, form into gas and create dry ice snow (frozen carbon dioxide). The liquid carbon dioxide is turned into a solid through depressurization.

CO₂ enters into a tank with normal atmospheric pressure through an expansion valve, which removes the liquid's pressure to allow it to gasify again. As the gas expands, it drops the temperature inside the tank, freezing a little less than half of the carbon dioxide into a solid before it can become a gas. This 42% of the carbon dioxide becomes snow, condensing onto the upper plate of a press, which then compresses it for example for about five minutes under 60 tons of force to create a block.

However, it is difficult to achieve the highest possible degree of mixing of fluids and to form the desired pressure and temperature in such systems. Therefore, there is a need for a nozzle for converting a liquid CO₂ into a dry ice at an optimal phase transformation during flocculation without accelerating the already formed snow particles or influencing them by auxiliary substances. Further, the nozzle should have a HX geometry shaped spherical chamber having tangential inlet for receiving liquid CO₂.

### SUMMARY OF THE INVENTION

It is accordingly an object of the invention to provide a nozzle for converting a liquid CO₂ into a dry ice which avoids these disadvantages and whose determining features are already taken into account in the dry ice making process, that is to say in the most essential process stages such as optimal phase transformation, collision and mixing, resulting in improvement of the economic efficiency of industrial dry ice production.

An object of the present invention is to provide the nozzle for converting a liquid CO₂ into a dry ice. The nozzle includes a housing, a spherical chamber configured in the housing, a first tangential inlet configured on the housing to tangentially inject the liquid CO₂ into the spherical chamber. Further, the tangential injection creates a helical flow of the liquid CO₂ inside the spherical chamber causing flocculation at a desired pressure and temperature to ensure optimum phase transformation to create the dry ice.

Another object of the present invention is to provide a HX geometry shaped housing. Further, the nozzle includes a second tangential inlet configured adjacent to the first tangential inlet to transfer a first secondary material into the spherical chamber to achieve highest possible degree of mixing, and resulting in the highest possible utilization of sub-cooling potential.

Another object of the present invention is to provide an inlet configured in the housing to receive a second secondary material to support expansion-based flocculation by thermally insulating the housing to achieve precooling of the spherical chamber. Further, the nozzle includes an outlet to discharge the dry ice.

Another object of the present invention is to provide the nozzle where the pressure is in the range of 0.25 to 0.95 bar, and the temperature is in the range of −80 to −95 degree Celsius.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 illustrates a cross-sectional perspective view of a nozzle in an embodiment of the present invention; and

FIG. 2 illustrates a top perspective cross-sectional view of the nozzle's spherical chamber in another embodiment of the present invention.

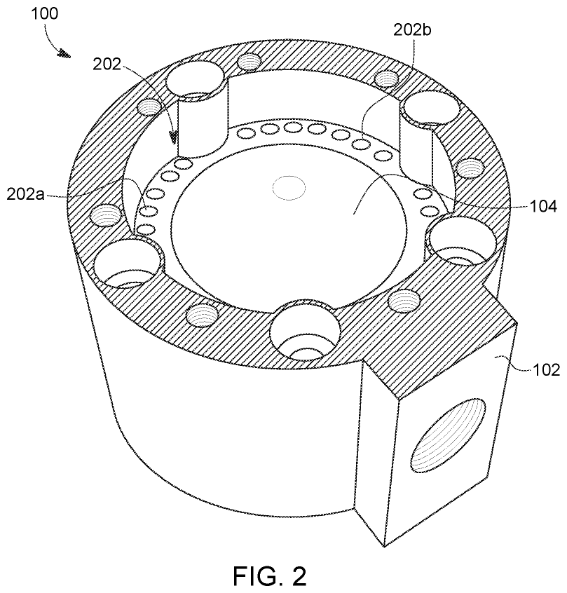

### DETAILED DESCRIPTION OF PREFERRED EMBODIMENTS

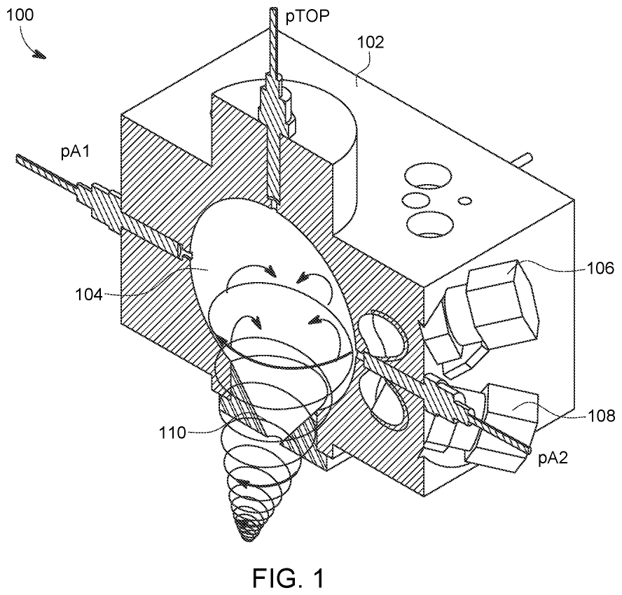

In drawing sheet 1, a FIG. 1 illustrates a cross-sectional perspective view of a nozzle 100, according to the invention in general technological process of dry ice. The nozzle is used for either separating or converting a liquid CO₂ or gaseous CO₂ into a dry ice. The nozzle according to the invention for producing dry ice, claimed according to the invention are explained in more detail in following exemplary embodiments.

### Example 1

A nozzle 100 converts a liquid CO₂ into a dry ice. The nozzle 100 includes a housing 102, a spherical chamber 104 configured in the housing 102 and a first tangential inlet 106 configured on the housing to tangential inject the liquid CO₂ into the spherical chamber 104. The tangential injection creates a helical flow of the liquid CO₂ inside the spherical chamber 104 causing flocculation at a desired pressure and temperature to ensure optimum phase transformation to create the dry ice.

The housing 102 is a HX geometry shaped. The HX geometry shaped housing 102 is a heat exchanger to transfer heat between a source and a working fluid. The flocculation of liquid CO₂ under fluid dynamic control to exploit the pressure dependence of the Joule-Thomson coefficient and the residence time of the liquid CO₂.

The HX geometry housing 102 is designed to control the pressure conditions and residence time of the liquid CO₂ to be flocculated in such a way that thermodynamic exploitation of the pressure dependence of the Joule-Thomson effect in absolute pressure ranges and the control of the residence time of the liquid CO₂ become possible. The following efficiency metrics are obtained from the Example 1:
Efficiency of CO₂ separation: 47% (benchmark: 42%)
Corrected Efficiency CO₂: 47% (benchmark: 42%)

### Example 2

The nozzle 100 includes a second tangential inlet 108 configured adjacent to the first tangential inlet to transfer a first secondary material into the spherical chamber to achieve highest possible degree of mixing, and resulting in the highest possible utilization of sub-cooling potential.

In an embodiment, the first secondary material is liquid nitrogen (N₂) is mixed with the liquid CO₂ in the spherical chamber (also termed as expansion chamber). Further, the first secondary material and the liquid CO₂ is injected with the aid of a driving potential. The strong tangential velocity component is generated during the injection of the two fluids into the housing 102 in order to achieve the highest possible degree of mixing and thus the highest possible utilization of the sub-cooling potential of the secondary material. This results in a so-called helical flow in the spherical chamber.

The thermodynamic condition that arises in this spherical chamber is influenced by process and geometry parameters. Both the pressure field and the temperature field are controlled within certain limits. It is found that the pressure and velocity field in the HX prototype variant depend strongly on both the chamber and outlet diameters, as well as on the angle and cross-sectional area of the tangential inlet relative to the horizontal, which gives rise to the possibility of extensively influencing the expansion event.

The liquid nitrogen is injected into the spherical chamber for maximum mixing by ensuring no entrainment effect is used for acceleration/transport of the liquid CO₂. A co-flow for entrainment is applied, no thermal shielding is created and a sheath flow is created which protects the core flow e.g. from freezing-out moisture.

The residence and interaction time of the liquid CO₂ with the N₂, are specifically controlled fluid dynamically. This limits the N₂ input to max. 30% of the inject liquid CO₂. The following efficiency metrics are obtained from the Example 2:
Efficiency of CO₂ separation: 65% (benchmark: 42%).
Corrected Efficiency CO₂: 55% (benchmark: 42%)

### Example 3

The nozzle 100 further includes one or more inlets 202 such as 202a & 202b. The inlets 202 are configured in the housing 102 to receive a secondary material (such as liquid Nitrogen) to support expansion based flocculation by thermally insulating the housing 102 to achieve precooling of the spherical chamber 104.

The housing 102 is configured to allow heat from a liquid CO₂ to pass to a N₂ without the two fluids having to mix together or come into direct contact. The liquid N₂ is used for flocculation of the liquid CO₂ under fluid dynamic control to exploit the pressure dependence of the Joule-Thomson coefficient and the residence time of the liquid CO₂. The liquid CO₂ is resided in the housing 102. The sensible and latent heat of the liquid N₂ is applied on the outer side in a re-cooling volume of the spherical chamber 104.

The housing 102 is designed to extend secondary-side re-cooling volume. The expansion and flocculation effect is increased by utilizing the sensible and latent heat of a liquid N₂ under complete separation with the liquid CO₂. The principle of keeping both liquid CO₂ and N₂ is explicitly not adiabatic. There is neither a mixing of the substances nor an acceleration nor a thermal insulation effect.

The following efficiency metrics are obtained from the Example 2:
Efficiency of CO₂ separation: 52% (benchmark: 42%)
Corrected Efficiency CO₂: 47% (benchmark: 42%)

As shown in FIG. 1, the nozzle 100 further includes an outlet 110 to discharge the dry ice. Circumference of the spherical chamber 104 provides a high pressure plane, and hollow portion of the spherical chamber 104 provides a low pressure volume and low temperature to the fluid/liquid. The high pressure plane and the low pressure & temperature provides a particle production area inside the spherical chamber resulting in creating a helix effect for production of dry ice.

As per the configuration of nozzle explained in Example 2 and 3, the dry ice may be formed from gaseous CO₂. The nozzle separates and converts a gaseous CO₂ into a dry ice. The nozzle is used for:
Direct flocculation of CO₂ from process gases and waste gases of various compositions in the field of carbon capture and utilization (CCU).
Direct flocculation of H₂O from process gases and exhaust gases of various compositions in the area of the CCU.
Process gas separation-separation of substances in mixtures (various compositions)

Although only a few embodiments of the present invention have been shown and described, it is to be understood that many changes and modifications may be made thereunto without departing from the spirit and scope of the invention.

### QUOTES INCLUDE IN THE DESCRIPTION

This list of the documents listed by the applicant has been generated automatically and is included solely for the better information of the reader.

### CITED PATENT LITERATURE

U.S. Pat. No. 7,762,869B2
EP3763481A1

What is claimed is:

1. A nozzle for converting a liquid CO₂ into a dry ice, the nozzle comprising:
a housing;
a spherical chamber configured in the housing; and
a first tangential inlet configured on the housing to tangential inject the liquid CO₂ into the spherical chamber;
wherein the tangential injection creates a helical flow of the liquid CO₂ inside the spherical chamber causing flocculation at a desired pressure and temperature to ensure optimum phase transformation to create the dry ice.

2. The nozzle according to claim 1, wherein the housing is HX geometry shaped.

3. The nozzle according to claim 1, further comprising a second tangential inlet configured adjacent to the first tangential inlet to transfer a first secondary material into the spherical chamber to achieve highest possible degree of mixing, and resulting in the highest possible utilization of sub-cooling potential.

4. The nozzle according to claim 1, further comprising one or more inlets configured in the housing to receive a second secondary material to support expansion-based flocculation by thermally insulating the housing to achieve precooling of the spherical chamber.

5. The nozzle according to claim 1, further comprising an outlet to discharge the dry ice.

6. The nozzle according to claim 1, wherein the pressure is in the range of 0.25 to 0.95 bar.

7. The nozzle according to claim 1, wherein the temperature is in the range of −80 to −95 degree Celsius.

8. A nozzle for converting a liquid CO₂ into a dry ice, the nozzle comprising:
a HX geometry shaped housing;
a spherical chamber configured in the HX geometry shaped housing; and
a first tangential inlet configured on the HX geometry shaped housing to transfer the liquid CO₂ into the spherical chamber causing a helical flow;
wherein the liquid CO₂ to be flocculated in the spherical chamber and forming a desired pressure and temperature field to ensure optimum phase transformation to discharge the dry ice.

9. The nozzle according to claim 8 further comprising a second tangential inlet configured adjacent to the first tangential inlet to transfer a first secondary material into the spherical chamber to achieve highest possible degree of mixing, and resulting in the highest possible utilization of sub-cooling potential.

10. The nozzle according to claim 8, further comprising an inlet configured in the housing to receive a second secondary material to support expansion-based flocculation by thermally insulating the housing to achieve precooling of the spherical chamber.

11. The nozzle according to claim 8, further comprising an outlet to discharge the dry ice.

12. The nozzle according to claim 8, wherein the pressure is in the range of 0.25 to 0.95 bar.

13. The nozzle according to claim 8, wherein the temperature is in the range of −80 to −95 degree Celsius.

14. A nozzle for separating and converting a gaseous CO₂ from a gas-mixture into a dry ice, the nozzle comprising:
a geometry shaped housing;
a spherical chamber configured in the geometry shaped housing; and
a first tangential inlet configured on the geometry shaped housing to transfer the gaseous CO₂ into the spherical chamber causing a helical flow;
wherein the gaseous CO₂ to be flocculated in the spherical chamber and forming a desired pressure and temperature field to ensure optimum phase transformation to discharge the dry ice.

15. The nozzle according to claim 14, further comprising a second tangential inlet configured adjacent to the first tangential inlet to transfer a first secondary material into the spherical chamber to achieve highest possible degree of mixing, and resulting in the highest possible utilization of sub-cooling potential.

16. The nozzle according to claim 14, further comprising an inlet configured in the housing to receive a second secondary material to support expansion-based flocculation by thermally insulating the housing to achieve precooling of the spherical chamber.

17. The nozzle according to claim 14, further comprising an outlet to discharge the dry ice.
